(19) United States
(12) Patent Application Publication
(10) Pub. No.: US 2025/0216681 A1
(43) Pub. Date: Jul. 3, 2025

(54) CONNECTABLE LENS ASSEMBLIES

(71) Applicant: Apple Inc., Cupertino, CA (US)

(72) Inventors: Ivan S. MARIC, Campbell, CA (US); Aidan N. ZIMMERMAN, Poway, CA (US); Shirley S. LU, Sunnyvale, CA (US)

(21) Appl. No.: 18/852,422

(22) PCT Filed: Apr. 6, 2023
(86) PCT No.: PCT/US2023/017787

§ 371 Date: Sep. 27, 2024

Related U.S. Application Data
(60) Provisional application No. 63/328,680, filed on Apr. 7, 2022.

(51) Int. Cl. G02B 27/01

(52) U.S. Cl. CPC G02B 27/0172; G02B 27/0176

(57) ABSTRACT

An electronic device can include lens assemblies that provide vision correction and are securely attached to optical assemblies of the electronic device. Each of the lens assemblies can maintain a position and orientation with respect to a corresponding one of the optical assemblies by the secure attachment. The attachment mechanisms can transition to extend during attachment and retract during detachment to maintain a low profile while separated. Such mechanisms can help ensure that the lens assembly is maintained at a desired position and orientation to provide the desired optical effect.

### CROSS-REFERENCE TO RELATED APPLICATION

This application claims the benefit of U.S. Provisional Application No. 63/328,680,entitled “HEAD-MOUNTABLE DEVICES WITH CONNECTABLE LENS MODULES,” filed Apr. 7, 2022, the entirety of which is incorporated herein by reference.

### TECHNICAL FIELD

The present description relates generally to electronic devices, and, more particularly, to electronic devices with connectable lens assemblies.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a rear view of the head-mountable device of FIG. 1, according to some embodiments of the present disclosure.

FIG. 3 illustrates an exploded perspective view of a lens assembly and an optical assembly of the head-mountable device of FIG. 1, according to some embodiments of the present disclosure.

FIG. 4 illustrates a sectional view of the lens assembly and the optical assembly of FIG. 3 in an unassembled configuration, according to some embodiments of the present disclosure.

FIG. 5 illustrates a sectional view of the lens assembly and the optical assembly of FIGS. 3 and 4 in an assembled configuration, according to some embodiments of the present disclosure.

FIG. 6 illustrates a sectional view of an optical assembly engager in a retracted configuration, according to some embodiments of the present disclosure.

FIG. 7 illustrates a sectional view of the optical assembly engager of FIG. 6 in an extended configuration, according to some embodiments of the present disclosure.

FIG. 8 illustrates a sectional view of an optical assembly engager in a retracted configuration, according to some embodiments of the present disclosure.

FIG. 9 illustrates a sectional view of the optical assembly engager of FIG. 8 in an extended configuration, according to some embodiments of the present disclosure.

FIG. 10 illustrates a sectional view of an optical assembly engager in a retracted configuration, according to some embodiments of the present disclosure.

FIG. 11 illustrates a sectional view of the optical assembly engager of FIG. 10 in an extended configuration, according to some embodiments of the present disclosure.

FIG. 12 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

Many of the functions performed by a head-mountable device are optimally experienced when the output is tailored to the needs of the user wearing the head-mountable device. In particular, the visual output features of a head-mountable device can be provided in a manner that accommodates a user's vision, including vision deficiencies and/or needs for vision correction. For example, a head-mountable device can include or be combinable with corrective lenses that allow a user to properly view the visual output features of the head-mountable device. To allow a given head-mountable device can be used by different users, the corrective lenses can be provided as a separate assembly that is attachable, removable, and/or exchangeable with other corrective lenses. Accordingly, any given user can properly view the visual output features when using the head-mountable device with an appropriate corresponding set of corrective lenses.

The position and orientation of a corrective lens with respect to the user and/or the display can affect the optical effect provided by the lens. As such, a particular corrective lens can be provided with an expectation that it will be maintained at a particular position and orientation with respect to the display and/or the user to provide the desired optical effect. As such, it can be desirable to maintain both the position and the orientation of the corrective lens with respect to the other elements of the head mountable device.

Systems, devices, and methods of the present disclosure can provide a head-mountable device with lens assemblies that provide vision correction and are securely attached to optical assemblies of the head-mountable device. Each of the lens assemblies can maintain a position and orientation with respect to a corresponding one of the optical assemblies by the secure attachment. The attachment mechanisms can transition to extend during attachment and retract during detachment to maintain a low profile while separated. Such mechanisms can help ensure that the lens assembly is maintained at a desired position and orientation to provide the desired optical effect.

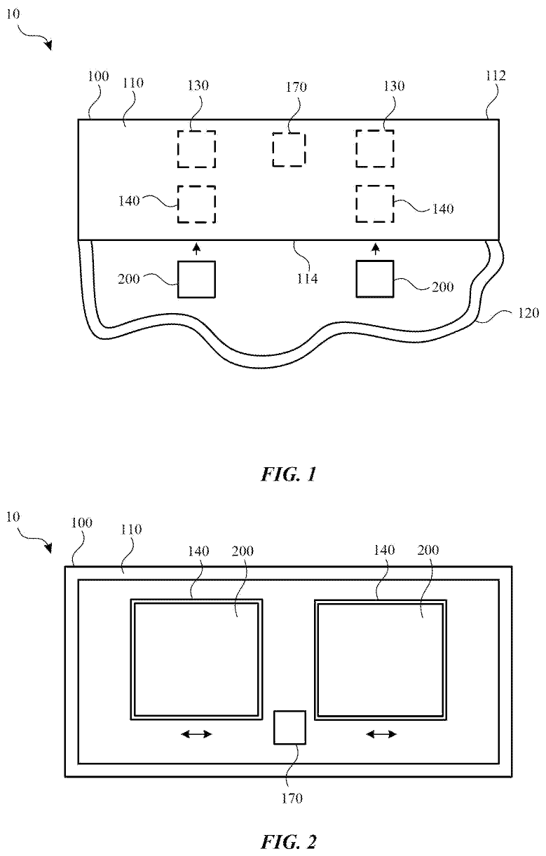

These and other embodiments are discussed below with reference to FIGS. 1-12. However, those skilled in the art will readily appreciate that the detailed description given herein with respect to these Figures is for explanatory purposes only and should not be construed as limiting.

According to some embodiments, for example as shown in FIG. 1, a head-mountable device 10 includes an HMD assembly 100 with a frame 110 that is worn on a head of a user. The frame 110 can be positioned in front of the eyes of a user to provide information within a field of view of the user. The HMD assembly 100 can provide nose pads or another feature to rest on a user's nose and/or engage other parts of the user's face.

The frame 110 can be supported on a user's head with the head engager 120. The head engager 120 can wrap or extend along opposing sides of a user's head. The head engager 120 can optionally include earpieces for wrapping around or otherwise engaging or resting on a user's ears. It will be appreciated that other configurations can be applied for securing the head-mountable device 10 to a user's head. For example, one or more bands, straps, belts, caps, hats, or other components can be used in addition to or in place of the illustrated components of the head-mountable device 10. By further example, the head engager 120 can include multiple components to engage a user's head.

The frame 110 can provide structure around a peripheral region thereof to support any internal components of the HMD assembly 100 in their assembled position. For example, the frame 110 can enclose and support various internal components (including for example integrated circuit chips, processors, memory devices and other circuitry) to provide computing and functional operations for the head-mountable device 10, as discussed further herein. While several components are shown within the frame 110, it will be understood that some or all of these components can be located anywhere within or on the head-mountable device 10. For example, one or more of these components can be positioned within the head engager 120 of the head-mountable device 10.

The frame 110 can include and/or support one or more cameras 130. The cameras 130 can be positioned on or near an outer side 112 of the frame 110 to capture images of views external to the head-mountable device 10. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 10 can include optical assemblies 140 that provide visual output for viewing by a user wearing the head-mountable device 10. One or more optical assemblies 140 can be positioned on or near an inner side 114 of the frame 110. As used herein, an inner side 114 of a portion of a head-mountable device is a side that faces toward the user and/or away from the external environment.

An optical assembly 140 can transmit light from a physical environment (e.g., as captured by a camera) for viewing by the user. Such an optical assembly 140 can include optical properties, such as lenses for vision correction based on incoming light from the physical environment. Additionally or alternatively, an optical assembly 140 can provide information as a display within a field of view of the user. Such information can be provided to the exclusion of a view of a physical environment or in addition to (e.g., overlaid with) a physical environment.

A physical environment refers to a physical world that people can interact with and/or sense without necessarily requiring the aid of an electronic device. A computer-generated reality environment relates to a partially or wholly simulated environment that people sense and/or interact with the assistance of an electronic device. Examples of computer-generated reality include, but are not limited to, mixed reality and virtual reality. Examples of mixed realities can include augmented reality and augmented virtuality. Examples of electronic devices that enable a person to sense and/or interact with various computer-generated reality environments include head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), smartphones, tablets, and desktop/laptop computers. A head-mountable device can have an integrated opaque display, have a transparent or translucent display, or be configured to accept an external opaque display from another device (e.g., smartphone).

Referring again to FIG. 1, the head-mountable device can include one or more lens assemblies 200. The lens assembly 200 can be or include one or more lenses for providing corrective vision capabilities. It will be understood that, where multiple lenses are used, the lenses of the lens assembly 200 can be provided together or separately (e.g., for combination). One lens assembly 200 can be applied to each of multiple (e.g., two) optical assemblies 140, as described further herein.

Referring now to FIG. 2, the optical assemblies of the head-mountable device can be adjustable to accommodate the facial features of the user wearing the head-mountable device and align each optical assembly with a corresponding eye of the user.

As shown in FIG. 2, the frame 110 can support a sensor 170. The sensor 170 can be positioned and arranged to detect a characteristic of the user, such as facial features. For example, such a user sensor can perform facial feature detection, facial movement detection, facial recognition, eye tracking, user mood detection, user emotion detection, voice detection, and the like.

As further shown in FIG. 2, each optical assembly 140 can be adjusted to align with a corresponding eye of the user. For example, each optical assembly 140 can be moved along one or more axes until a center of each optical assembly 140 is aligned with a center of the corresponding eye. Accordingly, the distance between the optical assemblies 140 can be set based on an interpupillary distance (“IPD”) of the user. IPD is defined as the distance between the centers of the pupils of a user's eyes.

The pair of optical assemblies 140 can be mounted to the frame 110 and separated by a distance. The distance between the pair of optical assemblies 140 can be designed to correspond to the IPD of a user. The distance can be adjustable to account for different IPDs of different users that may wear the head-mountable device 10. For example, either or both of the optical assemblies 140 may be movably mounted to the frame 110 to permit the optical assemblies 140 to move or translate laterally to make the distance larger or smaller. Any type of manual or automatic mechanism may be used to permit the distance between the optical assemblies 140 to be an adjustable distance. For example, the optical assemblies 140 can be mounted to the frame 110 via slidable tracks or guides that permit manual or electronically actuated movement of one or more of the optical assemblies 140 to adjust the distance there between.

Additionally or alternatively, the optical assemblies 140 can be moved to a target location based on a desired visual effect that corresponds to user's perception of the optical assembly 140 when it is positioned at the target location. The target location can be determined based on a focal length of the user and/or optical elements (e.g., lenses) of the system. For example, the user's eye and/or optical elements of the system can determine how the visual output of the optical assembly 140 will be perceived by the user. The distance between the optical assembly 140 and the user's eye and/or the distance between the optical assembly 140 and one or more optical elements can be altered to place the optical assembly 140 at, within, or outside of a corresponding focal distance. Such adjustments can be useful to accommodate a particular user's eye, corrective lenses, and/or a desired optical effect.

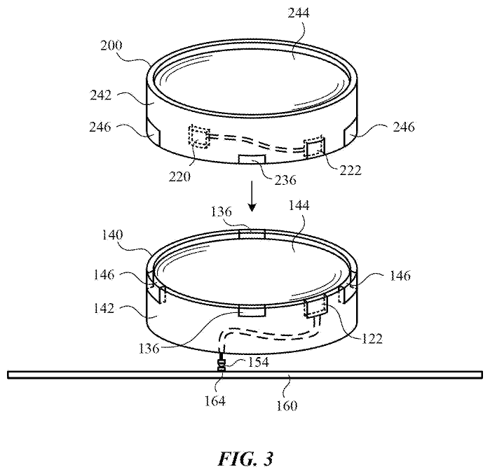

Referring now to FIG. 3, a lens assembly can be coupled to an optical assembly, and the optical assembly can provide an operable connection between the lens assembly and a control board of the head-mountable device.

As used herein, “modular” or “module” can refer to a characteristic that allows an item, such as a lens assembly, to be connected, installed, removed, swapped, and/or exchanged by a user in conjunction with another item, such as an optical assembly of a head-mounted device. Connection of a lens assembly with an optical assembly can be performed and reversed, followed by disconnection and connection of another lens assembly with the same optical assembly or another optical assembly with the same lens assembly. As such, multiple lens assemblies can be exchangeable with each other with respect to a given optical assembly. Further, multiple optical assemblies can be used with any given lens assembly.

A lens assembly can be connected to an optical assembly in a manner that allows the lens assembly to be removed thereafter. The connection can be fully reversible, such that when the lens assembly and the optical assembly are disconnected, each is restored to a condition held prior to the connection. The connection can be fully repeatable, such that after the lens assembly and the optical assembly are disconnected, the same or a different optical assembly and lens assembly pair can be connected in the same way.

A lens assembly and an optical assembly can be connected in a manner that secures the relative positions of the lens assembly and the optical assembly with respect to each other. The lens assembly and the optical assembly can be connected in a manner that provides a communication link there between. The secured positions and the communication link can both be achieved and maintained upon connection of the lens assembly and the optical assembly. The secured positions and the communication link can both be removed upon disconnection of the lens assembly from the optical assembly.

As shown in FIG. 3, each optical assembly 140 can include a display 144 within an optical assembly housing 142. The optical assembly housing 142 can surround an outer periphery of the display 144 and provide support thereto. Additionally, the optical assembly housing 142 can define at least a portion of a periphery of the optical assembly 140.

The display 144 of the optical assembly 140 can be operated to display visual information for a user. For example, the display 144 can provide visual (e.g., image or video) output by utilizing, for example, digital light projection, OLEDs, LEDs, uLEDs, liquid crystal on silicon, laser scanning light source, or any combination of these technologies. Operation of the display 144 can be controlled by a control board 160. The control board 160 can be operably connected to the display 144 of the optical assembly 140 by one or more of a variety to connections.

The lens assembly 200 can optionally include an electronic component 220 that provides one or more functions to the head-mountable device when the lens assembly 200 is coupled to the optical assembly 140. The electronic component 220 can be operably connected to the head-mountable device (e.g., the control board 160) by the optical assembly 140. Accordingly, the electronic component 220 of the lens assembly 200 can be operably connected to the control board 160 and/or other components of the head-mountable device through the lens assembly connector 222, the inner optical assembly connector 122, the outer optical assembly connector 154, and/or the control board connector 164.

As further shown in FIG. 3, each lens assembly 200 can include a lens 244 within a lens assembly housing 242. The lens assembly housing 242 can surround an outer periphery of the lens 244 and provide support thereto. Additionally, the lens assembly housing 242 can define at least a portion of a periphery of the lens assembly 200.

The lens 244 can provide one or more types of optical effects and/or vision correction. Lenses 244 can include other optical components as required to produce a desired optical effect. For example, lenses 244 can provide vision correction to light as appropriate for a given user. Such correction can be spherical, aspheric, atoric, cylindrical, single vision, multifocal, progressive, and/or adjustable. By further example, lenses 244 can include one or more diffusers, filters, polarizers, prisms, beam splitters, diffraction gratings, mirrors, and/or windows. The differences in correction or other effects among lenses 244 of different lens assemblies 200 can include variations in type of correction, diopter power, axis of correction, and the like. Various combinations of corrections can be provided with different lens assemblies 200. Accordingly, different users can use different lens assemblies 200 and/or no lens assembly 200 as desired.

The lens assembly 200 can include one or more lens assembly couplers 236 (e.g., magnets) supported by the lens assembly housing 242, and the optical assembly 140 can include one or more optical assembly couplers 136 (e.g., magnets) supported by the optical assembly housing 142. The lens assembly couplers 236 and the optical assembly couplers 136 can facilitate coupling of the lens assembly 200 to the optical assembly 140 in a relative position and/or orientation that aligns the lens 244 of the lens assembly 200 in a preferred position and orientation relative to the display 144 of the optical assembly 140. For example, the lens assembly couplers 236 can releasably engage optical assembly couplers 136 of the optical assembly 140 to couple the lens assembly 200 to the optical assembly 140. Such coupling can help maintain the lens assembly 200 within a particular distance with respect to the optical assembly 140. It will be understood that such placement can allow the lens assembly 200 to be securely held in any location that places the lens 244 within a field of view of the user and/or between the user and the display 144 of the optical assembly 140.

One or more of various couplers can be provided to secure the assemblies to each other. For example, mechanisms such as locks, latches, snaps, slides, channels, screws, clasps, threads, magnets, pins, an interference (e.g., friction) fit, knurl presses, bayoneting, fused materials, weaves, knits, braids, hook and loop fasteners, and/or combinations thereof can be included to couple and/or secure the assemblies together. The assemblies can remain secured to each other until an optional release mechanism is actuated. The release mechanism can be provided for access by a user.

Where multiple (e.g., left and right) lens assemblies 200 and optical assemblies 140 are provided, the optical assembly couplers 136 and the lens assembly couplers 236 can have different features, so that coupling and engagement is limited to be between corresponding (e.g., left or right) lens assemblies 200 and optical assemblies 140. For example, an arrangement of optical assembly couplers 136 can be between different optical assemblies 140, and an arrangement of lens assembly couplers 236 can be different between different lens assemblies 200. Such differences in arrangement can include position and orientation with respect to the corresponding housing, magnetic polarity, shape, size, and the like. As such, a particular lens assembly 200 (e.g., left or right) can be provided with features such that it can only be securely coupled to a correspondingly particular (e.g., left or right) optical assembly 140.

In some embodiments, the engagement of the lens assembly couplers 236 and the optical assembly couplers 136 may have a limited ability to maintain the lens assembly 200 within a particular range of rotational orientation with respect to the optical assembly 140. For example, where the optical assembly couplers 136 and/or the lens assembly couplers 236 comprise magnets that attract each other, the lens assembly 200 can be maintained against and in contact with the optical assembly 140, but a range of different rotational orientations may be provided, such that the lens assembly 200 and the optical assembly 140 may not necessarily have a target relative rotational orientation based on the engagement of the optical assembly couplers 136 and the lens assembly couplers 236.

As further shown in FIG. 3, the lens assembly 200 can include one or more lens assembly engagers 246 supported by the lens assembly housing 242, and the optical assembly 140 can include one or more receptacles 148 defined by the optical assembly housing 142. The lens assembly engagers 246 and the receptacles 148 can facilitate engagement of the lens assembly 200 to the optical assembly 140 in a relative orientation that rotationally aligns the lens 244 of the lens assembly 200 in a preferred orientation relative to the display 144 of the optical assembly 140. For example, the lens assembly engagers 246 can extend into the receptacles 148 of the optical assembly 140 to engage the lens assembly 200 with the optical assembly 140. Such engagement can help maintain the lens assembly 200 within a particular rotational orientation with respect to the optical assembly 140. For example, while the lens assembly engagers 246 are within the receptacles 148, the optical assembly housing 142 can form walls of the receptacles 148 that limit movement of the lens assembly engagers 246 therein. Such limits can maintain the lens assembly 200 in a preferred orientation relative to the optical assembly 140.

One or more of various engagers can be provided to secure the assemblies to each other. For example, mechanisms such as locks, latches, snaps, slides, channels, screws, clasps, threads, magnets, pins, an interference (e.g., friction) fit, knurl presses, bayoneting, fused materials, weaves, knits, braids, hook and loop fasteners, and/or combinations thereof can be included to promote engagement to maintain a desired relative rotational orientation.

Where multiple (e.g., left and right) lens assemblies 200 and optical assemblies 140 are provided, the receptacles 148 and the lens assembly engagers 246 can have different features, so that engagement is limited to be between corresponding (e.g., left or right) lens assemblies 200 and optical assemblies 140. For example, an arrangement of receptacles 148 can be between different optical assemblies 140, and an arrangement of lens assembly engagers 246 can be different between different lens assemblies 200. Such differences in arrangement can include position and orientation with respect to the corresponding housing, shape, size, and the like. As such, a particular lens assembly 200 (e.g., left or right) can be provided with features such that it can only be securely coupled to a correspondingly particular (e.g., left or right) optical assembly 140.

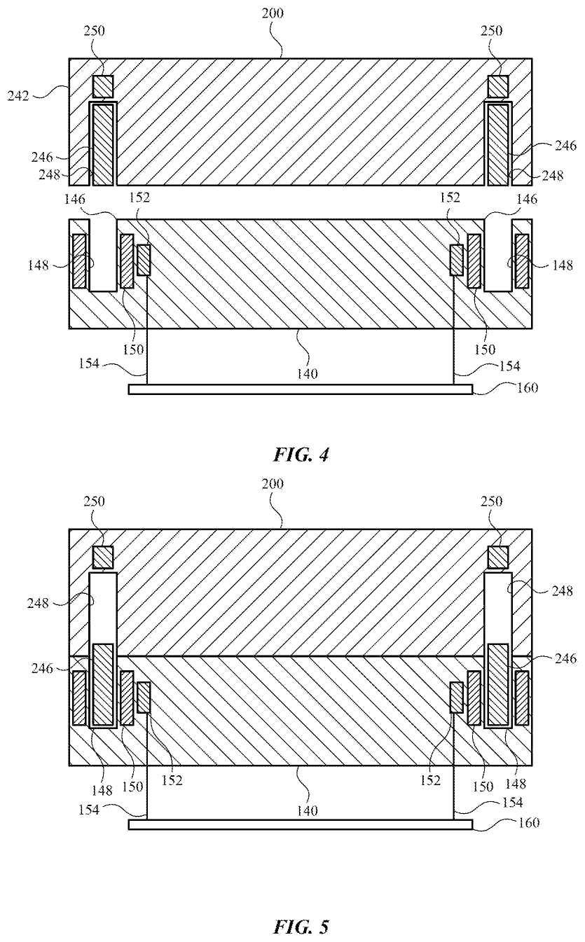

Referring now to FIGS. 4 and 5, the engagers of a lens assembly can move between retracted and extended configurations to controllably engage with receptacles of an optical assembly.

As shown in FIG. 4, the lens assembly engagers 246 are shown in a retracted configuration within recesses 248 defined by the lens assembly housing 242. The lens assembly engagers 246 can be in the retracted configuration when the lens assembly 200 is spaced apart from and/or otherwise not coupled to the optical assembly 140. While in the retracted configuration, the lens assembly engagers 246 may be fully or at least partially within the corresponding recesses 248. Optionally, the lens assembly in engagers 246 can be flush with the lens assembly housing 242. As such, the lens assembly engagers 246 can be protected and avoid interference with other objects while the lens assembly 200 is not coupled to the optical assembly 140.

A biaser 250 can be provided to bias the lens assembly engagers 246 toward the retracted configuration. In some embodiments, the biaser 250 can include a magnet (e.g., a permanent magnet or actively controlled magnet) that generates a magnetic field to magnetically attract the lens assembly engager 246 toward the retracted configuration. In some embodiments, the biaser 250 can include an elastic element to mechanically bias the lens assembly engager 246, as described further herein.

As shown in FIG. 5, the lens assembly engagers 246 are shown in an extended configuration at least partially out of the recesses 248 defined by the lens assembly housing 242. The lens assembly engagers 246 can move to an extended configuration when the lens assembly 200 is contacting and/or otherwise coupled to the optical assembly 140. While the in the extended configuration, the lens assembly engagers 246 may at least partially extend out of the corresponding recesses 248 and at least somewhat beyond the lens assembly housing 242. While the in the extended configuration, the lens assembly engagers 246 can further extend into a corresponding receptacle 148 of the optical assembly 140.

An extender 150 can be provided by the optical assembly to urge the lens assembly engagers 246 toward the extended configuration. In some embodiments, the extender 150 can include a magnet (e.g., a permanent magnet or actively controlled magnet) that generates a magnetic field to magnetically attract the lens assembly engager 246 toward the extended configuration. In some embodiments, the extender 150 can include another element to mechanically urge the lens assembly engager 246.

The biasing action provided by the biaser 250 can be overcome to allow and/or encourage the lens assembly engagers 246 to transition from the retracted configuration to an extended configuration. The force to extend the lens assembly engagers 246 can be applied and sufficient to cause extension when within a certain distance thereof, such as when the lens assembly 200 is coupled to the optical assembly 140. For example, a force applied by the biaser 250 can have a relatively greater influence on the lens assembly engager 246 while of the lens assembly 200 is not coupled to the optical assembly 140. In such a configuration, the biaser 250 may apply a force that is greater than those of more distant influences. A force applied by the extender 150 can have a relatively greater influence on the lens assembly engager 246 while the lens assembly 200 is coupled to the optical assembly 140. In such a configuration, the extender 150 (e.g., a magnet) can urge the lens assembly engager 246 with a force that is greater than the force applied by the biaser 250. For example, where the biaser 250 and the extender 150 are magnets, the extender 150 can generate a stronger magnetic field in the region of the lens assembly engagers 246 than does the biaser 250 while the lens assembly 200 is coupled to the optical assembly 140.

In some embodiments, the optical assembly 140 can detect the presence and/or engagement status of the lens assembly 200. As shown in FIGS. 4 and 5, the optical assembly 140 comprises a detector 152. The detector 152 can be operated to detect the presence or absence of the lens assembly engagers 246 and/or another component of the lens assembly 200. For example, where the lens assembly engager 246 comprises a magnetic material, the detector 152 can include a Hall effect sensor and/or magnetometer for detecting changes in the magnetic field in the vicinity of the optical assembly 140. When the lens assembly engager 246 moves into the receptacle 148 of the optical assembly 140, the detector 152 can detect a magnetic field and/or change in magnetic field that is indicative of the presence of the lens assembly engager 246 and engagement of the lens assembly 200 with the optical assembly 140. By further example, the detector 152 can include an electromechanical switch for detecting contact and/or forces from the lens assembly engager 246. Such an electromechanical switch can extend at least partially into the receptacle 148. When the lens assembly engager 246 moves into the receptacle 148 of the optical assembly 140, the detector 152 can be actuated by the lens assembly engager 246 to indicate its presence and/or engagement of the lens assembly 200 with the optical assembly 140. Additionally or alternatively, the detector 152 can include one or more other sensors, such as optical sensors, pressure sensors, electrical sensors, chemical sensors, and the like.

One or more of the detectors 152 can be operatively connected to a control board 160 and/or other control circuity of the lens assembly 200 and/or the head-mountable device. For example, the detectors 152 can be connected via one or more cables, flex circuits, and the like, such as by the outer optical assembly connector 154 and/or another connector.

In some embodiments, one or more components of the head-mountable device can respond to a detection that the lens assembly 200 has engaged the optical assembly 140. For example, the head-mountable device can provide a notification, such as a light (e.g., emitting light and/or flashing) if the head-mountable device is off of a head of a user while the detection is made. By further example, a light (e.g., LED) of the head-mountable device (e.g., positioned at a frame thereof and/or at the lens assembly 200 can emit light. By further example, the display of the head-mountable device can provide a notification (e.g., popup notification) if the head-mountable device is worn by a user.

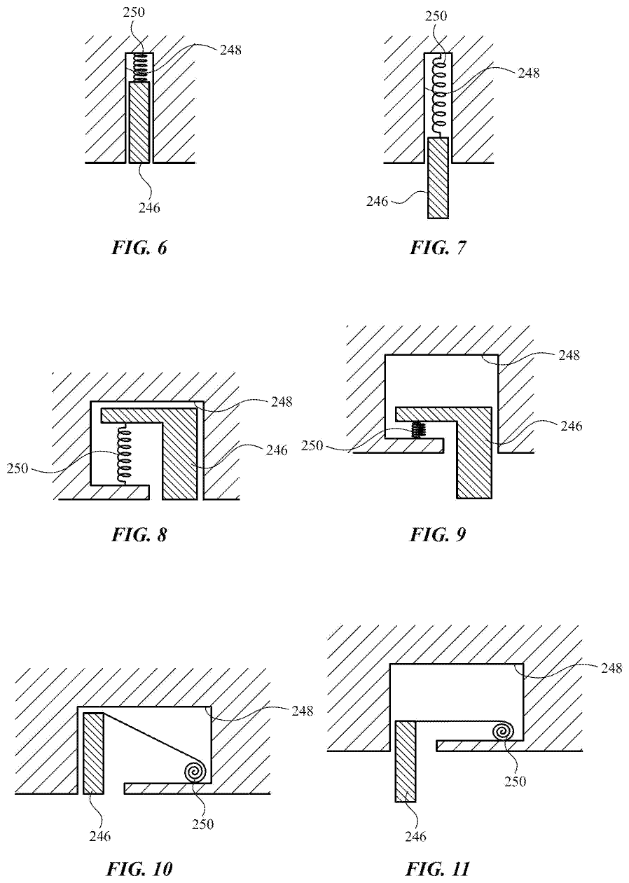

Referring now to FIGS. 6 and 7, the biaser 250 can be a type of elastic element that mechanically biases the lens assembly engager 246. For example, the biaser 250 can be or include a tension spring that tends toward a shortened length to bias the lens assembly engager 246 to be within the recess 248. The effect of the tension spring can be overcome by an extender when the while the lens assembly is coupled to the optical assembly.

Referring now to FIGS. 8 and 9, the biaser 250 can be another type of elastic element that mechanically biases the lens assembly engager 246. For example, the biaser 250 can be or include a compression spring that tends toward a longer length to bias the lens assembly engager 246 to be within the recess 248. The effect of the tension spring can be overcome by an extender when the while the lens assembly is coupled to the optical assembly.

Referring now to FIGS. 10 and 11, the biaser 250 can be yet another type of elastic element that mechanically biases the lens assembly engager 246. For example, the biaser 250 can be or include a torsion spring that tends toward a rotational position to bias the lens assembly engager 246 to be within the recess 248. The effect of the torsion spring can be overcome by an extender when the while the lens assembly is coupled to the optical assembly.

It will be understood that a variety of other types of biasers can be provided in addition to and/or as an alternative to those depicted herein. Such mechanisms can be provided in combination to provide the desired effect.

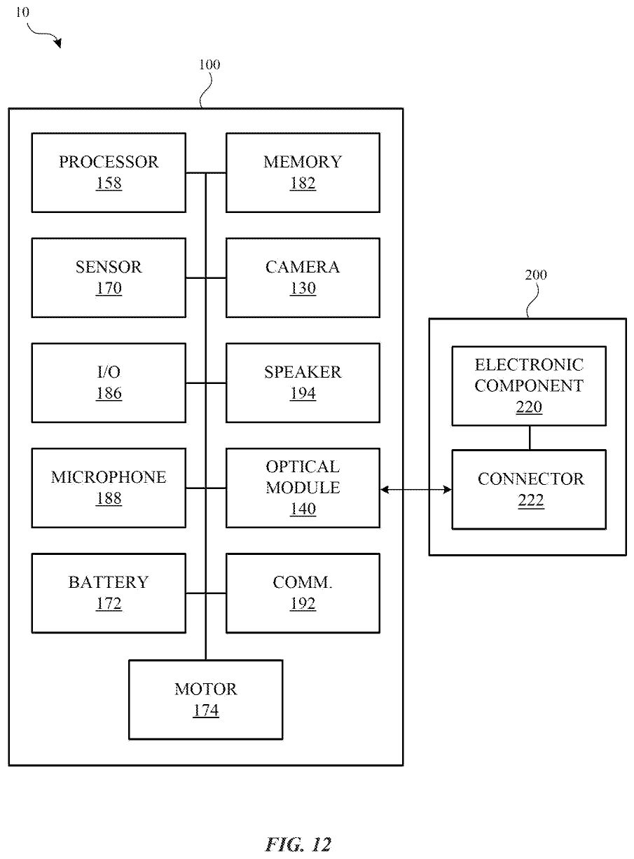

Referring now to FIG. 12, components of the head-mountable device can be operably connected to provide the performance described herein. FIG. 12 shows a simplified block diagram of an illustrative head-mountable device 10 in accordance with one embodiment of the invention. It will be appreciated that components described herein can be provided on one, some, or all of an HMD assembly, a face engager, a lens assembly, and/or a head engager. It will be understood that additional components, different components, or fewer components than those illustrated may be utilized within the scope of the subject disclosure.

As shown in FIG. 12, the head-mountable device 10 can include a processor 158 (e.g., control circuity) with one or more processing units that include or are configured to access a memory 182 having instructions stored thereon. The instructions or computer programs may be configured to perform one or more of the operations or functions described with respect to the head-mountable device 10. The processor 158 can be implemented as any electronic device capable of processing, receiving, or transmitting data or instructions. For example, the processor 158 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The processor can be a component of and/or operably connected to the control board and/or another component of the head-mountable device.

The memory 182 can store electronic data that can be used by the head-mountable device 10. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 10 can include adjustment control components described herein, such as a motor 174, an actuator, and the like for moving components (e.g., optical assemblies 140) to a desired relative position and/or orientation.

The head-mountable device 10 can include one or more sensors 170, such as the sensors of a sensor assembly, as described herein.

The head-mountable device 10 can include an input/output component 186, which can include any suitable component for connecting head-mountable device 10 to other devices. Suitable components can include, for example, audio/video jacks, data connectors, or any additional or alternative input/output components. The input/output component 186 can include buttons, keys, or another feature that can act as a keyboard for operation by the user.

The head-mountable device 10 can include the microphone 188 as described herein. The microphone 188 can be operably connected to the processor 158 for detection of sound levels and communication of detections for further processing, as described further herein.

The head-mountable device 10 can include the speakers 194 as described herein. The speakers 190 can be operably connected to the processor 158 for control of speaker output, including sound levels, as described further herein.

The head-mountable device 10 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 10 can include a battery 172, which can charge and/or power components of the head-mountable device 10. The battery 172 can also charge and/or power components connected to the head-mountable device 10 (e.g., the lens assembly 200).

As shown in FIG. 12, the lens assembly 200 can include an electronic component 220 that is operably connected to the head-mountable device 10 through a lens assembly connector 222 and the optical assembly 140 (e.g., connector thereof). Accordingly, every component of the head-mountable device 10 can be operably connected to every component (e.g., electronic component 220) of the lens assembly 200.

Accordingly, embodiments of the present disclosure provide a head-mountable device with lens assemblies that provide vision correction and are securely attached to optical assemblies of the head-mountable device. Each of the lens assemblies can maintain a position and orientation with respect to a corresponding one of the optical assemblies by the secure attachment. The attachment mechanisms can transition to extend during attachment and retract during detachment to maintain a low profile while separated. Such mechanisms can help ensure that the lens assembly is maintained at a desired position and orientation to provide the desired optical effect.

Various examples of aspects of the disclosure are described below as clauses for convenience. These are provided as examples, and do not limit the subject technology.

Clause A: a head-mountable device comprising: an optical assembly comprising: a display; and an optical assembly housing surrounding a periphery of the display, the optical assembly forming a receptacle; and a lens assembly comprising: a lens; a lens assembly housing surrounding a periphery of the lens; and a lens assembly engager configured to transition from a first position within the lens assembly housing and a second position protruding from the lens assembly housing and into the receptacle.

Clause B: a lens assembly comprising: a lens; a lens assembly housing surrounding a periphery of the lens; and a lens assembly engager configured to transition between: a first configuration within the lens assembly housing while the lens assembly is not coupled to an optical assembly of a head-mountable device; and a second configuration protruding from the lens assembly housing while the lens assembly is coupled to the optical assembly.

Clause C: a lens assembly comprising: a lens; a lens assembly housing surrounding a periphery of the lens; a lens assembly engager; and a biaser configured to bias the lens assembly engager towards the lens assembly housing, the lens assembly engager being moveable away from the lens assembly housing by a magnet of an optical assembly of a head-mountable device when the lens assembly is coupled to the optical assembly.

One or more of the above clauses can include one or more of the features described below. It is noted that any of the following clauses may be combined in any combination with each other, and placed into a respective independent clause, e.g., clause A, B, C, or D.

Clause 1: the optical assembly further comprises an optical assembly coupler; and the lens assembly further comprises a lens assembly coupler, wherein when the optical assembly coupler and the lens assembly coupler engage each other, the lens assembly is maintained within a distance with respect to the optical assembly.

Clause 2: the lens assembly engager is protruding from the lens assembly housing and into the receptacle, the lens assembly is maintained within a range of rotational orientation with respect to the optical assembly.

Clause 3: the optical assembly coupler and the lens assembly coupler each comprise a magnet.

Clause 4: when the optical assembly coupler and the lens assembly coupler engage each other, the lens assembly engager is configured to transition to the second position.

Clause 5: the lens assembly further comprises a first magnet; and the optical assembly further comprises a second magnet.

Clause 6: the first magnet is configured to bias the lens assembly engager towards the lens assembly housing, and the second magnet is configured to move the lens assembly engager away from the lens assembly housing when the lens assembly is coupled to the optical assembly.

Clause 7: the lens assembly further comprises an elastic biaser configured to bias the lens assembly engager towards the lens assembly housing.

Clause 8: the optical assembly further comprises a magnet, and the lens assembly engager is moveable away from the lens assembly housing by the magnet when the lens assembly is coupled to the optical assembly.

Clause 9: the optical assembly is a first optical assembly; the lens assembly is a first lens assembly; the lens assembly housing is a first lens assembly housing; the lens assembly engager is a first lens assembly engager; and the head-mountable device further comprises: a second optical assembly; and a second lens assembly comprising a second lens assembly housing and a second lens assembly engager.

Clause 10: an arrangement of the first lens assembly engager with respect to the first lens assembly housing is different than an arrangement of the second lens assembly engager with respect to the second lens assembly housing.

Clause 11: a camera; a microphone; a speaker; a control board operably coupled to the optical assembly; a frame supporting the control board, the optical assembly, the camera, the microphone, and the speaker; and a head engager configured to secure the frame to head of a user.

Clause 12: a first magnet configured to bias the lens assembly engager toward the first configuration, wherein the lens assembly engager is configured to be moved to the second configuration by a second magnet of the optical assembly.

Clause 13: the lens assembly further comprises an elastic biaser configured to bias the lens assembly engager towards the first configuration.

Clause 14: a lens assembly coupler configured to engage an optical assembly coupler of the optical assembly, wherein when the optical assembly coupler and the lens assembly coupler engage each other, the lens assembly is maintained within a distance with respect to the optical assembly.

Clause 15: the magnet is a first magnet; and the biaser comprises a second magnet.

Clause 16: the biaser comprises a spring.

Clause 17: a lens assembly coupler configured to engage an optical assembly coupler of the optical assembly, wherein when the optical assembly coupler and the lens assembly coupler engage each other, the lens assembly is maintained within a distance with respect to the optical assembly.

As described herein, aspects of the present technology can include the gathering and use of data. The present disclosure contemplates that in some instances, gathered data can include personal information or other data that uniquely identifies or can be used to locate or contact a specific person. The present disclosure contemplates that the entities responsible for the collection, analysis, disclosure, transfer, storage, or other use of such personal information or other data will comply with well-established privacy practices and/or privacy policies. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
an optical assembly comprising:
a display; and
an optical assembly housing surrounding a periphery of the display, the optical assembly forming a receptacle; and
a lens assembly comprising:
a lens;
a lens assembly housing surrounding a periphery of the lens; and
a lens assembly engager configured to transition from a first position within the lens assembly housing and a second position protruding from the lens assembly housing and into the receptacle.

2. The head-mountable device of claim 1, wherein:
the optical assembly further comprises an optical assembly coupler; and
the lens assembly further comprises a lens assembly coupler, wherein when the optical assembly coupler and the lens assembly coupler engage each other, the lens assembly is maintained within a distance with respect to the optical assembly.

3. The head-mountable device of claim 2, wherein the lens assembly engager is protruding from the lens assembly housing and into the receptacle, the lens assembly is maintained within a range of rotational orientation with respect to the optical assembly.

4. The head-mountable device of claim 2, wherein the optical assembly coupler and the lens assembly coupler each comprise a magnet.

5. The head-mountable device of claim 2, wherein when the optical assembly coupler and the lens assembly coupler engage each other, the lens assembly engager is configured to transition to the second position.

6. The head-mountable device of claim 1, wherein:
the lens assembly further comprises a first magnet; and
the optical assembly further comprises a second magnet.

7. The head-mountable device of claim 6, wherein the first magnet is configured to bias the lens assembly engager towards the lens assembly housing, and the second magnet is configured to move the lens assembly engager away from the lens assembly housing when the lens assembly is coupled to the optical assembly.

8. The head-mountable device of claim 1, wherein the lens assembly further comprises an elastic biaser configured to bias the lens assembly engager towards the lens assembly housing.

9. The head-mountable device of claim 8, wherein the optical assembly further comprises a magnet, and the lens assembly engager is moveable away from the lens assembly housing by the magnet when the lens assembly is coupled to the optical assembly.

10. The head-mountable device of claim 1, wherein:
the optical assembly is a first optical assembly;
the lens assembly is a first lens assembly;
the lens assembly housing is a first lens assembly housing;
the lens assembly engager is a first lens assembly engager; and
the head-mountable device further comprises:
a second optical assembly; and
a second lens assembly comprising a second lens assembly housing and a second lens assembly engager.

11. The head-mountable device of claim 10, wherein an arrangement of the first lens assembly engager with respect to the first lens assembly housing is different than an arrangement of the second lens assembly engager with respect to the second lens assembly housing.

12. The head-mountable device of claim 1, further comprising:
a camera;
a microphone;
a speaker;
a control board operably coupled to the optical assembly;
a frame supporting the control board, the optical assembly, the camera, the microphone, and the speaker; and
a head engager configured to secure the frame to a head.

13. A lens assembly comprising:
a lens;
a lens assembly housing surrounding a periphery of the lens; and
a lens assembly engager configured to transition between:
a first configuration within the lens assembly housing while the lens assembly is spaced apart from an optical assembly of a head-mountable device; and
a second configuration protruding from the lens assembly housing while the lens assembly is contacting the optical assembly.

14. The lens assembly of claim 13, further comprising a first magnet configured to bias the lens assembly engager toward the first configuration, wherein the lens assembly engager is configured to be moved to the second configuration by a second magnet of the optical assembly.

15. The lens assembly of claim 13, wherein the lens assembly further comprises an elastic biaser configured to bias the lens assembly engager towards the first configuration.

16. The lens assembly of claim 13, further comprising a lens assembly coupler configured to engage an optical assembly coupler of the optical assembly, wherein when the optical assembly coupler and the lens assembly coupler engage each other, the lens assembly is maintained within a distance with respect to the optical assembly.

17. A lens assembly comprising:
a lens;
a lens assembly housing surrounding a periphery of the lens;
a lens assembly engager; and
a biaser configured to bias the lens assembly engager towards the lens assembly housing, the lens assembly engager being moveable away from the lens assembly housing by a magnet of an optical assembly of a head-mountable device when the lens assembly is coupled to the optical assembly.

18. The lens assembly of claim 17, wherein:
the magnet is a first magnet; and
the biaser comprises a second magnet.

19. The lens assembly of claim 17, wherein the biaser comprises a spring.

20. The lens assembly of claim 17, further comprising a lens assembly coupler configured to engage an optical assembly coupler of the optical assembly, wherein when the optical assembly coupler and the lens assembly coupler engage each other, the lens assembly is maintained within a distance with respect to the optical assembly.
